(19) United States
(12) Patent Application Publication
(10) Pub. No.: US 2019/0085544 A1
(43) Pub. Date: Mar. 21, 2019

(54) FACILITY DEVICE

(71) Applicant: LIXIL Corporation, Tokyo (JP)

(72) Inventors: Hiroto KUTSUZAWA, Tokyo (JP); Nobuyuki MATSUDA, Tokyo (JP); Makoto KOTEGAWA, Tokyo (JP); Keiko NAKAGAWA, Tokyo (JP); Yoshifumi OGAWA, Tokyo (JP); Tomokazu TOYA, Tokyo (JP); Toshihiko KOMATSU, Tokyo (JP); Kentarou TSUJI, Tokyo (JP)

(73) Assignee: LIXIL Corporation, Tokyo (JP)

(21) Appl. No.: 16/130,453

(22) Filed: Sep. 13, 2018

(30) Foreign Application Priority Data
Sep. 15, 2017 (JP) 2017-177665

(51) Int. Cl. E03D 5/01; A47K 17/00; E03D 5/10; A47K 13/24; G01S 17/02

(52) U.S. Cl. CPC E03D 5/01; A47K 17/00; G01S 17/026; A47K 13/24; E03D 5/105

(57) ABSTRACT

A facility device includes a sensor which includes a light transmitting unit that transmits an optical signal and a light receiving unit that receives a reflected signal which is the optical signal transmitted from the light transmitting unit, reached a target object, and reflected, the light receiving unit transmitting a detection signal on the basis of the received reflected signal; and a panel which is arranged at a position in a first direction from the sensor. A display portion is provided on the panel, the display portion being configured to guide the target object to be placed at a predetermined position. The light transmitting unit includes a first light transmitting unit that is arranged to be capable of being directed toward a location which is in the first direction from the display portion. The display portion is arranged adjacent to the sensor in a front view of the facility device.

### REFERENCE TO RELATED APPLICATIONS

This application claims the priority of Japanese Patent Application No. 2017-177665, filed Sep. 15, 2017, the entire contents of which are incorporated herein by reference.

### FIELD OF THE INVENTION

The invention relates to a facility device.

### BACKGROUND OF THE INVENTION

Conventionally, in order to prevent sounds generated at the time of excretion from being heard outside of a toilet compartment, a sound imitating device generating a water flowing sound of a flushing toilet or a river stream sound is installed. A sound imitating device in which functional components such as a sensor, a stop switch, and a speaker main body are housed inside a case, and a front cover is disposed on the front side of the case (user side) is proposed (see Japanese Unexamined Patent Application, First Publication No. 2012-90971).

In addition, a sensor in which a light transmitting device and a light receiving device are disposed as a pair on a substrate and separated by a light shielding wall inside a case of which a front side is open, and an opening of the case is covered by a transparent cover is proposed (see Japanese Unexamined Patent Application, First Publication No. 2001-250979).

Furthermore, as a sensor of a sound imitating device disposed in a toilet compartment, a sensor in which a pictogram (pictographic script) representing a hand is disposed on a front surface (a surface on a user side) of a cover covering the sensor to indicate that a hand is to be held over this portion is proposed. A configuration in which an optical signal transmitted from the light transmitting device arrives at the hand and is reflected, and the light receiving device receives a reflected signal is employed.

### SUMMARY OF THE INVENTION

In a sound imitating device in which the pictogram as described above is disposed, there is a possibility that an optical signal transmitted from the light transmitting device will be blocked by the pictogram and not reach the hand, and a reflected signal that has been reflected by hand will be blocked by the pictogram and not reach the light receiving device. For this reason, there is a problem in that a hand (target object) held in front of the sensor cannot be detected.

The invention is in view of the situations described above and provides a facility device capable of accurately detecting a target object.

According to a first aspect of the invention, there is provided a facility device including: a sensor which includes a light transmitting unit that transmits an optical signal and a light receiving unit that receives a reflected signal which is the optical signal transmitted from the light transmitting unit, reached a target object, and reflected, the light receiving unit transmitting a detection signal on the basis of the received reflected signal; and a panel which is arranged at a position in a first direction from the sensor. A display portion is provided on the panel, the display portion being configured to guide the target object to be placed at a predetermined position. The light transmitting unit includes a first light transmitting unit that is arranged to be capable of being directed toward a location which is in the first direction from the display portion. The display portion is arranged adjacent to the sensor in a front view of the facility device.

In the facility device configured in this way, the display portion displayed in the panel arranged in front of the sensor is arranged adjacent to the sensor in the front view. Accordingly, the display portion is not arranged to overlap the sensor in the front view, and thus an optical signal transmitted from the light transmitting unit is not blocked by the display portion. In addition, a first light transmitting unit that is arranged to be capable of being directed toward a location which is in the first direction from the display portion. Accordingly, the optical signal transmitted from the first light transmitting unit arrives at the target object arranged at a position in a first direction from the sensor. Furthermore, the display portion is not arranged to overlap the sensor in the front view, and accordingly, a reflected signal that is reflected when an optical signal reaches the target object is not blocked by the display portion and arrives at the light receiving unit. Therefore, the sensor can accurately detect the target object.

In addition, in the facility device according to a second aspect of the invention, the first light transmitting unit may be oriented toward a direction that goes closer to the display portion in the front view of the facility device as gradually going to the first direction.

In the facility device configured in this way, for example, even when the center of a user's hand is arranged at a position deviating from the first light transmitting device to the display portion side, since the first light transmitting unit is oriented toward a direction that goes closer to the display portion in the front view of the facility device as gradually going to the first direction, the user's hand can be detected reliably.

In addition, in the facility device according to a third aspect of the invention, the light transmitting unit may include a second light transmitting unit arranged to be capable of being directed toward the first direction. The first light transmitting unit may be arranged closer to the display portion than the second light transmitting unit in the front view of the facility device.

In the facility device configured in this way, the first light transmitting unit is arranged in closer proximity to the display portion than the second light transmitting unit. Accordingly, the first light transmitting unit can reliably detect a target object shown in the display portion. In addition, the second light transmitting unit disposed to be able to be directed toward the front side can detect a user in front of the facility device (human body detection).

In addition, the facility device according to a fourth aspect of the invention may further include a control unit which transmits an output signal that causes a predetermined function to be executed on the basis of the detection signal and a function executing unit which executes the predetermined function on the basis of the output signal. When the detection signal is received during an execution of the predetermined function, the control unit transmits a stop signal that causes the predetermined function to be stopped. The function executing unit stops the execution of the predetermined function on the basis of the stop signal.

In the facility device configured in this way, when a detection signal is received during execution of a predetermined function, the control unit transmits a stop signal that causes the predetermined function to be stopped. The function executing unit stops the execution of the predetermined function on the basis of the stop signal. Accordingly, by detecting a target object using one sensor, execution and stopping of the predetermined function can be performed, and thus it is not necessary to separately prepare a sensor for the execution of the predetermined function and a sensor for stopping the predetermined function, and compactness of the facility device can be achieved.

### BRIEF DESCRIPTION OF THE DRAWINGS

FIG. 1 is a perspective view seen from a diagonally forward side of a sound imitating device according to one embodiment of the invention.

FIG. 2 is an exploded perspective view of a sound imitating device according to one embodiment of the invention and is a view seen from a diagonally forward side.

FIG. 3 is an exploded perspective view of a sound imitating device according to one embodiment of the invention and is a view seen from a diagonally backward side.

FIG. 4 is a cross-sectional view taken along line A-A illustrated in FIG. 1.

FIG. 5 is a front view of a sound imitating device according to one embodiment of the invention.

FIG. 6 is a perspective view of a flushing switching device according to a modified example of one embodiment of the invention that is seen from a diagonally forward side.

FIG. 7 is a perspective view of a flushing switching device according to the modified example of one embodiment of the invention that is seen from above.

FIG. 8 is a view of a flushing switching device according to the modified example of one embodiment that is seen from the top with an upper panel removed from an upper case body.

### DETAILED DESCRIPTION OF THE INVENTION

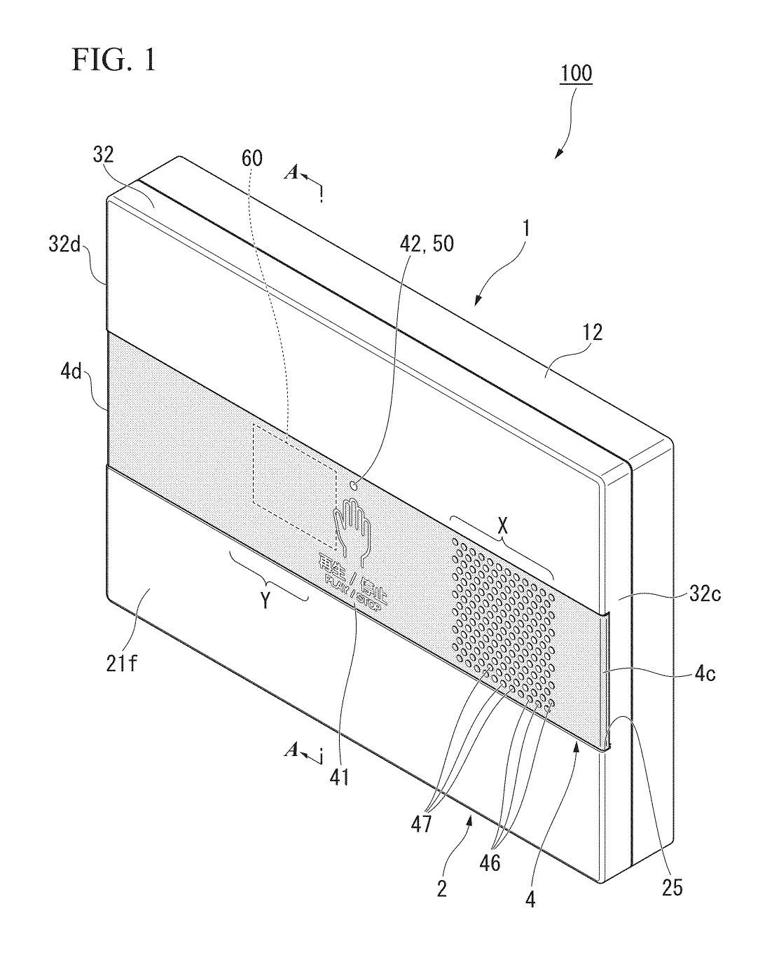

Hereinafter, a sound imitating device will be described with reference to FIGS. 1 to 4 as an example of a facility device according to one embodiment of the invention.

FIG. 1 is a perspective view seen from a forward side of a sound imitating device according to one embodiment of the invention.

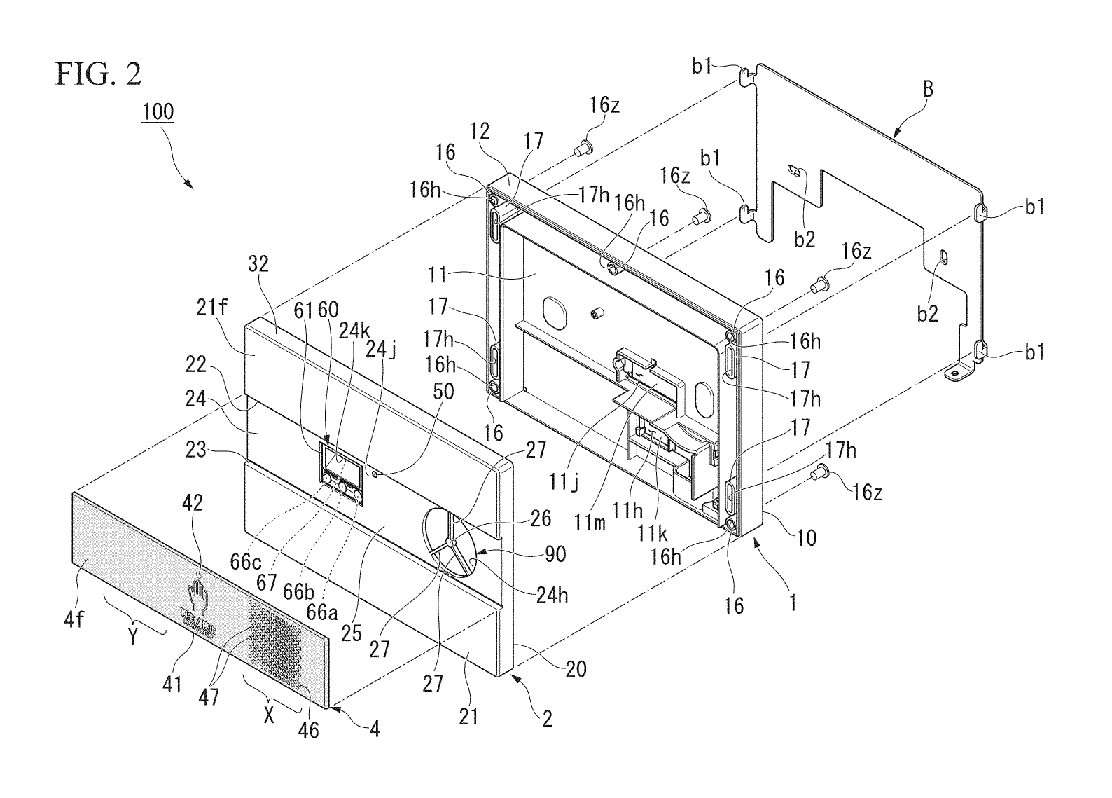

The sound imitating device 100 illustrated in FIG. 1 is used for generating an imitation sound. The sound imitating device 100 is mounted on a wall (not illustrated in the drawing) of a toilet compartment or the like through a bracket B (see FIG. 2).

In the following description, a user side facing the sound imitating device 100 will be referred to as a front side, a side opposite to the user (wall side) will be referred to as a back side, and a direction between the front side and the back side will be referred to as a forward/backward direction. In addition, a left side as seen by a user will be referred to as a left side, a right side as seen by a user will be referred to as a right side, and a direction between the left side and the right side will be referred to as a leftward/rightward direction.

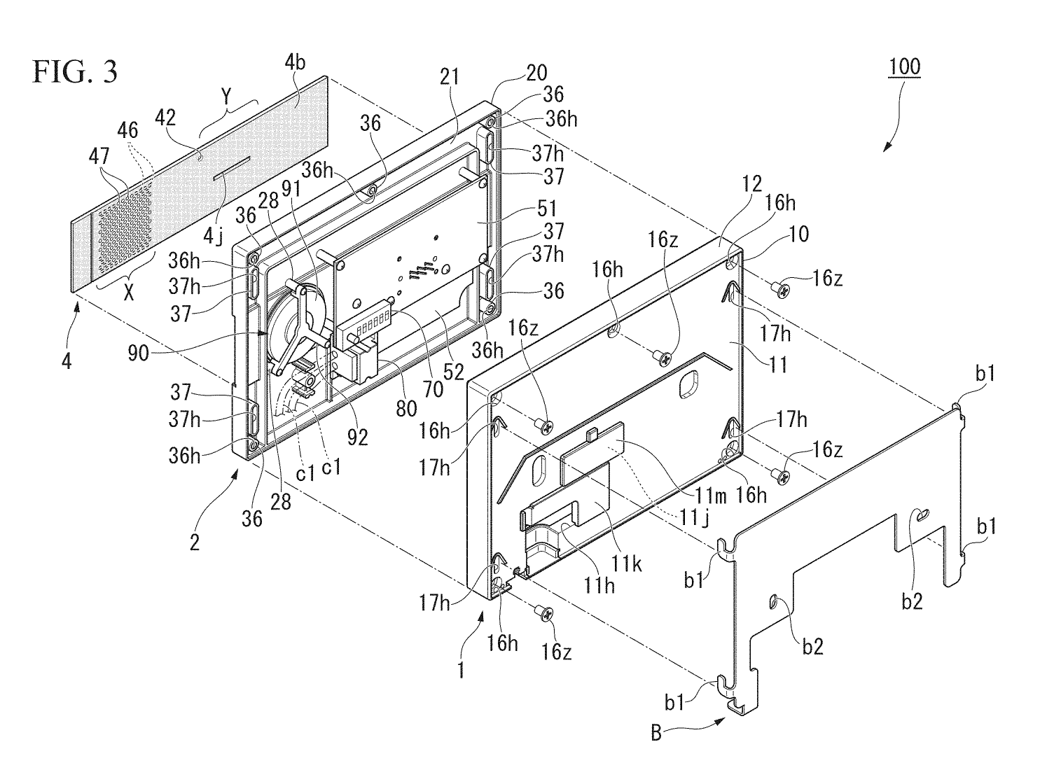

FIG. 2 is an exploded perspective view of the sound imitating device 100 and is a view seen from a diagonally forward side. FIG. 3 is an exploded perspective view of the sound imitating device 100 and is a view seen from a diagonally backward side. In addition, in FIGS. 2 and 3, the bracket B used for mounting the sound imitating device 100 on the wall is illustrated as well.

As illustrated in FIGS. 2 and 3, the sound imitating device 100 includes a lower case 1, an upper case 2, and a front panel (panel) 4.

As illustrated in FIG. 2, the lower case 1 includes a rear case main body 10. The rear case main body 10 is formed in a rectangular shape when seen in a front view (seen from the front side) and includes a rear plate part 11 of which a plate thickness direction is directed in the forward/backward direction.

In an outer edge portion of the rear plate part 11, a rear side wall part 12 erected toward the front side is provided. The rear side wall part 12 is provided over the whole circumference of the outer edge portion of the rear plate part 11.

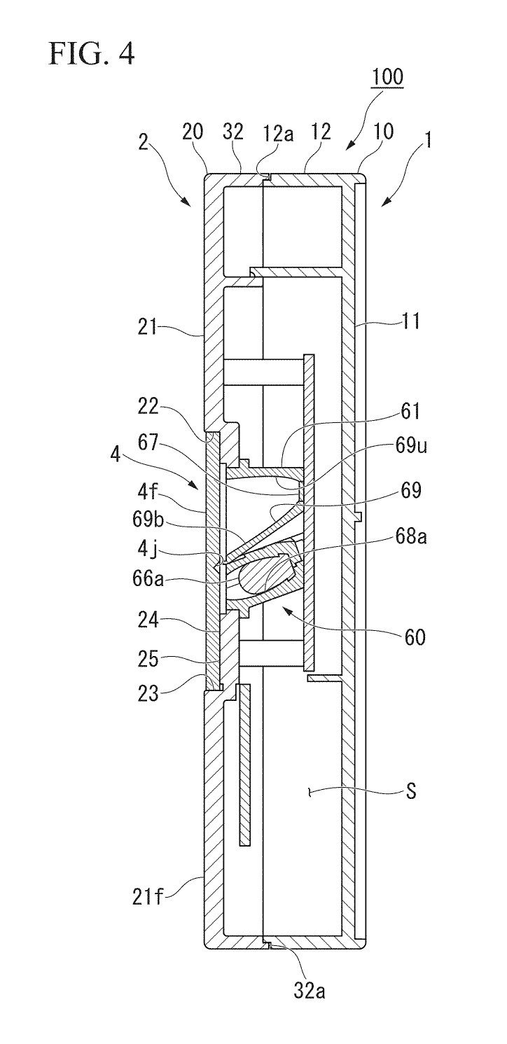

FIG. 4 is a cross-sectional view taken along line A-A illustrated in FIG. 1 and is a cross-sectional view passing through a light transmitting device 66a of a sensor unit 60 to be described later.

As illustrated in FIG. 4, a stair part 12a concaved toward the back side is formed on an outer edge side of a front end portion of the rear side wall part 12. The stair part 12a is formed on the whole circumference of the rear side wall part 12.

As illustrated in FIG. 2, a fixed cylindrical part 16 protruding to the front side is provided in the rear plate part 11. The fixed cylindrical part 16 is formed in a cylindrical shape having the forward/backward direction as its axial line direction. A through hole 16h communicating from the rear plate part 11 to the fixed cylindrical part 16 and passing through in the forward/backward direction is formed. The fixed cylindrical part 16 is provided at four corners of the rear plate part 11 and the approximate center of an upper portion of the rear plate part 11 in the leftward/rightward direction in an upper part.

A cylindrical locking part 17 protruding forward is provided in the rear plate part 11. The cylindrical locking part 17 is formed in a cylindrical shape which is long in the vertical direction and which is formed in the forward/backward direction as the axial line direction. A through hole 17h communicating from the rear plate part 11 to the cylindrical locking part 17 and penetrating in the forward/backward direction is formed. The cylindrical locking part 17 is provided in the vicinity of four corners of the rear plate part 11. In more details, the cylindrical locking part 17 is provided slightly below the fixed cylindrical part 16 provided at the corner portion of the upper part of the rear plate part 11 and slightly above the fixed cylindrical part 16 provided at the corner portion of the lower part of the rear plate part 11. A locking piece b1 of the bracket B can be locked in the cylindrical locking part 17.

As illustrated in FIG. 3, a wire pulling-in opening 11h is formed in a lower part of the rear plate part 11. A VVF cable c1 to be described later can be inserted into and pass through the wire pulling-in opening 11h.

A power supply cover 11k that can be freely open or closed from the rear face of the rear plate part 11 is provided on the wire pulling-in opening 11h.

In the rear plate part 11, a switch opening 11j is formed above the wire pulling-in opening 11h. A switch cover 11m that can be freely open or closed from the rear face of the rear plate part 11 is provided on the switch opening 11j.

As illustrated in FIG. 2, the upper case 2 includes a front case main body 20. The front case main body 20 includes a front plate part 21 having a rectangular shape in the front view and having a plate thickness direction directed in the forward/backward direction.

As illustrated in FIGS. 2 to 4, the front plate part 21 is arranged in front of the rear plate part 11 of the lower case 1. A housing space S is formed between the front plate part 21 and the rear plate part 11 of the lower case 1. The housing space S can house an operating lamp 50, a sensor unit (sensor) 60, a speaker unit (function executing unit) 90, a first substrate 51, a second substrate 52, a terminal unit 80, a switch 70, and the like.

As illustrated in FIG. 2, an upper wall part 22 and a lower wall part 23 are formed in an intermediate portion of a front face 21f of the front plate part 21 in a vertical direction. The upper wall part 22 and the lower wall part 23 bend from the front face 21f of the front plate part 21 toward the back side. The upper wall part 22 and the lower wall part 23 are formed in the whole length of the front plate part 21 in the horizontal direction. The upper wall part 22 is arranged above the lower wall part 23. A rear end portion of the upper wall part 22 and a rear end portion of the lower wall part 23 are connected through a bottom wall part 24.

An engaging concave part 25 that is concaved from the front face 21f of the front plate part 21 to the back side is formed by these upper wall part 22, lower wall part 23, and bottom wall part 24. The engaging concave part 25 is formed at the approximate center of the front plate part 21 in the vertical direction. The engaging concave part 25 is formed over the whole length of the front plate part 21 in the horizontal direction. The engaging concave part 25 is formed in a rectangular shape that is long in the horizontal direction in the front view.

A speaker mounting hole 24h, a lamp mounting hole 24j, and a sensor mounting hole 24k are formed in the bottom wall part 24 of the engaging concave part 25. Each of the mounting holes 24h, 24j, and 24k is formed by penetrating the front plate part 21 (the bottom wall part 24) in the forward/backward direction. The speaker mounting hole 24h, the lamp mounting hole 24j, and the sensor mounting hole 24k are arranged in that order from the right side to the left side in the front view.

The speaker mounting hole 24h is formed in an approximately circular shape in the front view. A center connection part 26 forming an approximately circular shape is provided at the center of the speaker mounting hole 24h. Connection parts 27 extending to an upper side, a lower left side, and a lower right side are provided at the center connection part 26.

End portions of the three connection piece parts 27 provided on a side opposite to the center connection part 26 side are connected to an outer edge portion of the speaker mounting hole 24h of the bottom wall part 24 of the engaging concave part 25.

The lamp mounting hole 24j is formed in an approximately circular shape in the front view. The sensor mounting hole 24k is formed in a rectangular shape in the front view.

A front side wall part 32 erected toward the back side is provided in an outer edge portion of the front plate part 21. The front side wall part 32 is provided over the whole circumference of the outer edge portion of the front plate part 21.

As illustrated in FIG. 4, a protruding wall part 32a protruding to the back side is formed on the outer edge side of the rear end portion of the front side wall part 32. The protruding wall part 32a is arranged to face the stair part 12a of the rear side wall part 12 of the lower case 1, and the protruding wall part 32a and the stair part 12a are engaged with each other. Accordingly, the upper case 2 and the lower case 1 are assembled, and movement in the vertical direction and the horizontal direction is regulated.

As illustrated in FIG. 3, a fixed cylindrical part 36 protruding to the back side is provided on a rear face of the front plate part 21. The fixed cylindrical part 36 is formed in a cylindrical shape having the forward/backward direction as its axial line direction. A mounting hole 36h extending in the forward/backward direction is formed in the fixed cylindrical part 36. A female screw (not illustrated in the drawing) is formed in the mounting hole 36h. The fixed cylindrical part 36 is provided at a position corresponding to the fixed cylindrical part 16 of the lower case 1, and the mounting hole 36h of the fixed cylindrical part 36 communicates with the through hole 16h of the fixed cylindrical part 16 of the lower case 1. A screw 16z that is inserted into and passes through the through hole 16h of the fixed cylindrical part 16 of the lower case 1 from the rear side is screwed into the mounting hole 36h of the fixed cylindrical part 36 of the upper case 2.

A cylindrical locking part 37 protruding to the back side is provided on a rear face of the front plate part 21. The cylindrical locking part 37 is formed in a cylindrical shape, which is long in the vertical direction and which is formed in the forward/backward direction as the axial line direction. A mounting hole 37h extending in the forward/backward direction is formed in the cylindrical locking part 37. The cylindrical locking part 37 is provided at a position corresponding to the cylindrical locking part 17 of the lower case 1, and the mounting hole 37h of the cylindrical locking part 37 communicates with the through hole 17h of the cylindrical locking part 17 of the lower case 1. A protrusion piece (not illustrated in the drawing) protruding to the lower side is provided on an upper face of the through hole 17h. A locking piece b1 of the bracket B that is inserted into and passes through the through hole 17h is locked into the protrusion piece. In more details, a lower part of the locking piece b1 is arranged below the protrusion piece, and a tip end portion of the locking piece b1 is arranged on the front side of the protrusion piece over the through hole 17h to the mounting hole 37h.

An operating lamp 50, a first substrate 51, a sensor unit 60, a switch 70, a second substrate 52, a terminal unit 80, and a speaker unit 90 are attached to the upper case 2 as functional units.

The operating lamp 50 is provided in the lamp mounting hole 24j from the rear side of the upper case 2.

The first substrate 51 is provided in a rear portion of the upper case 2. The sensor unit 60 illustrated in FIG. 2 is provided on a front face of the first substrate 51.

The sensor unit 60 is arranged in the sensor mounting hole 24k of the upper case 2. The sensor unit 60 includes a casing 61, three light transmitting devices (light transmitting units, first light transmitting units) 66a arranged inside the casing 61, light transmitting devices (light transmitting units; second light transmitting units) 66b and 66c, and a light receiving device (light receiving unit) 67.

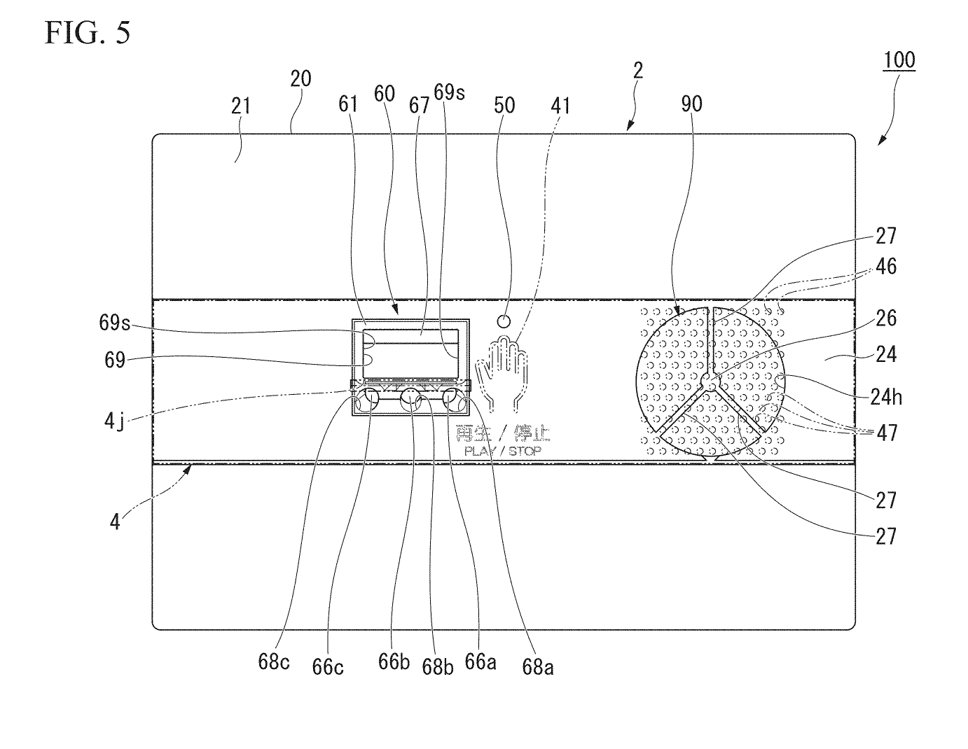

FIG. 5 is a front view of the sound imitating device 100, and a front panel 4 is denoted using a two-dot chain line.

As illustrated in FIG. 5, light transmitting concave parts 68a, 68b, and 68c that are concave from the front face toward the back side are formed in the casing 61. The light transmitting concave parts 68a, 68b, and 68c are arranged in that order from the right side to the left side with spaces interposed therebetween in the front view.

As illustrated in FIGS. 4 and 5, the light transmitting concave parts 68a are directed gradually toward the lower side and the right side as going from the back to the front. As illustrated in FIG. 5, the light transmitting concave part 68b is formed to be directed gradually toward the lower side as going from the back to the front. The light transmitting concave part 68c is formed to be directed gradually toward the lower side and the left side as going from the back to the front.

The light transmitting devices 66a, 66b, and 66c are provided in rear portions of the light transmitting concave parts 68a, 68b, and 68c.

Among the light transmitting concave parts 68a, 68b, and 68c, the light transmitting device 66a arranged on the rightmost side in the front view (closest to operation information 41) is oriented toward a direction that goes closer to the operation information 41 as gradually going to the first direction. In other words, the light transmitting device 66a can detect (orient) a hand held up to the front side of the operation information 41, a user present in front of the sensor unit 60, and the like by transmitting an optical signal toward the front side of the operation information 41 in correspondence with the shape of the light transmitting concave part 68a (a direction gradually toward the right side as going to the front side).

Among the light transmitting concave parts 68a, 68b, and 68c, the light transmitting device 66b arranged at the center in the front view can detect a user present in front of the sensor unit 60 by transmitting an optical signal toward the front side in correspondence with the shape of the light transmitting concave part 68b.

Among the light transmitting concave parts 68a, 68b, and 68c, the light transmitting device 66c arranged on the leftmost side in the front view can detect a user present in front of the sensor unit 60 by transmitting an optical signal gradually toward the left side in correspondence with the shape of the light transmitting concave part 68c as going to the front side.

Transmission ranges of optical signals transmitted from the light transmitting devices 66a, 66b, and 66c form an approximately fan shape as a whole.

A light receiving concave part 69 that is concave from the front face toward the back side is formed in the casing 61. The light receiving concave part 69 is arranged above the light transmitting concave parts 68a, 68b, and 68c. The light receiving concave part 69 is formed from the light transmitting concave part 68a over a length that is approximately the same as the whole length of the light transmitting concave part 68c in the horizontal direction.

As illustrated in FIG. 4, the light receiving concave part 69 has an upper face 69u formed along an approximately horizontal face and has a lower face 69b gradually directed toward a lower side as going to the front side. As illustrated in FIG. 5, a side face 69s of the light receiving concave part 69 is formed along an approximately vertical plane. A light receiving device 67 is provided at a rear portion of the light receiving concave part 69.

Optical signals are transmitted from the light transmitting devices 66a, 66b, and 66c, the optical signals reach a target object and are reflected, and reflected signals are received by the light receiving device 67, whereby the sensor unit 60 detects presence/absence of the target object. For example, a light emitting diode (LED) or the like may be employed as each of the light transmitting devices 66a, 66b, and 66c, and a light receiving IC or the like may be employed as the light receiving device 67.

As illustrated in FIG. 3, a switch 70 that can adjust the volume of an imitation sound output from the speaker unit 90 and the like is provided on a rear face of the first substrate 51. The switch 70 is arranged inside the switch opening 11j of the lower case 1.

The second substrate 52 is provided in a rear portion of the upper case 2. A terminal unit 80 to which the VVF cable c1 is connected is provided at a rear face of the second substrate 52. The terminal unit 80 is arranged inside the wire pulling-in opening 11h of the lower case 1.

The speaker unit 90 is provided in a rear portion of the upper case 2. The speaker unit 90 includes a speaker main body 91 and a speaker attaching part 92. The speaker attaching part 92 has a shape corresponding to the center connection part 26 and the connection piece part 27 provided in the speaker hole 47 of the upper case 2 illustrated in FIG. 2. The speaker main body 91 is interposed between the rear face of the upper case 2 and the speaker attaching part 92. The speaker attaching part 92 is screwed into a fixed piece 28 protruding from the rear face of the front plate part 21 of the upper case 2 to the back side. The speaker unit 90 is arranged behind the speaker mounting hole 24h in correspondence with the position of the speaker mounting hole 24h formed in the upper case 2.

When the sensor unit 60 detects the presence of a target object, a detection signal supplied from the light receiving device 67 of the sensor unit 60 is transmitted to a control unit not illustrated in the drawing. When the detection signal is received, the control unit transmits an output signal to the speaker unit 90. The output signal causes a predetermined function to be executed on the basis of the detection signal. When the output signal is received, the speaker unit 90 outputs an imitation sound, and the imitation sound is stopped after a predetermined time elapses. In addition, when the presence of a target object is detected by the sensor unit 60 during the output of the imitation sound, a detection signal supplied from the sensor unit 60 is transmitted to the control unit not illustrated in the drawing. When the detection signal is received, the control unit transmits a stop signal to the speaker unit 90. When the stop signal is received, the speaker unit 90 stops the output of the imitation sound.

As illustrated in FIG. 1, the front panel 4 is arranged in the horizontal direction that is along the engaging concave part 25 along the engaging concave part (front face) 25 of the upper case 2. The front panel 4 is formed in a plate shape, is formed in a rectangular shape in the front view, and has a plate thickness direction directed in the forward/backward direction. The front panel 4 is formed in a shape corresponding to the engaging concave part 25 of the upper case 2. In other words, a length of the front panel 4 in the vertical direction is approximately the same as a length from the upper wall part 22 to the lower wall part 23 of the engaging concave part 25. A length of the front panel 4 in the horizontal direction is approximately the same as a length of the engaging concave part 25 in the horizontal direction (a length of the front plate part 21 of the upper case 2 in the horizontal direction). A thickness of the front panel 4 is approximately the same as a depth of the engaging concave part 25 (a length in the forward/backward direction). In the front view, a right end part 4c and a left end part 4d of the front panel 4 are arranged to respectively overlap a right end part 32c and a left end part 4d of the upper case 2. An end face of the right end part 4c and an end face of the left end part 4d of the front panel 4 are exposed without being covered with the upper case 2.

As illustrated in FIG. 4, the front panel 4 is locked in the engaging concave part 25. In this embodiment, the front panel 4 is mounted in the bottom wall part 24 of the engaging concave part 25 of the upper case 2 using a double-sided tape (not illustrated in the drawing) stuck on the rear face.

A front face 4f of the front panel 4 is arranged on approximately the same plane as the front face 21f of the upper case 2. In more details, the front face 4f of the front panel 4 is arranged on a slightly behind the front face 21f of the upper case 2.

As illustrated in FIG. 2, the front panel 4 is arranged at a position in a first direction from the sensor unit 60. That is, the front panel 4 is arranged in front of the sensor unit 60. Operation information (display portion) 41 guiding a target object to a predetermined position is arranged at the approximately center of the front panel 4 in the horizontal direction. In other words, as illustrated in FIG. 5, the operation information 41 is arranged on the right side of the panel than the sensor unit 60 while being adjacent to the sensor unit 60 in the front view. In this embodiment, as the operation information 41, a pictogram (pictographic script) representing a hand and texts written as “play/stop” and “PLAY/STOP” are illustrated. In addition, the operation information 41 may be configured by only a pictogram or only texts.

As illustrated in FIG. 2, in the front panel 4, a lamp transmitting part 42 through which light of the operating lamp 50 to be described later can be transmitted is provided above the operation information 41. The lamp transmitting part 42 is provided at a position corresponding to the operating lamp 50.

On the right side of the front panel 4, a speaker hole 47 and a dummy hole 46 form a column in which the holes are arranged to have a space therebetween in the vertical direction, and a plurality of columns are arranged in the horizontal direction to have a space therebetween. The columns are arranged to be in an approximately rectangular shape as a whole in the front view and a speaker area X is formed.

In the speaker area X, a plurality of dummy holes 46 are formed at four corners. The dummy hole 46 is a hole that does not pass through the front panel 4 in a plate thickness direction. In this embodiment, the dummy hole 46 has a shape that is concave from the front face 4f of the front panel 4 to the back side.

In the speaker area X, a plurality of speaker holes 47 passing through the plate thickness direction are formed at places other than the dummy holes 46. The speaker holes 47 are formed at positions corresponding to the speaker mounting holes 24h of the upper case 2.

A left side of the front panel 4 is set as a sensor area Y into which the light transmitting devices 66a, 66b, and 66c of the sensor unit 60 to be described later can diffuse. The sensor area Y is provided at a position corresponding to the sensor unit 60.

In the rear face 4b of the sensor area Y of the front panel 4, a groove part 4j is formed at a height position between the light transmitting devices 66a, 66b, and 66c and the light receiving device 67. The groove part 4j is concave from the rear face 4b to the front side and extends in the horizontal direction. The groove part 4j is formed over the approximately same length as the whole length of the light receiving concave part 69. As illustrated in FIG. 4, the groove part 4j has a shape of which the front end portion is sharp in a vertical sectional view along the forward/backward direction (approximately, a triangle) such that a vertical length is gradually shortened as going to the front side. By disposing this groove part 4j, weak light from the light transmitting devices 66a, 66b, and 66c is blocked, and light from the light transmitting devices 66a, 66b, and 66c is configured not to be directly inserted into the light receiving device 67.

In this embodiment, the front panel 4 is molded from a transparent acrylic resin, and then, the groove part 4j is formed in the sensor area Y. Thereafter, the operation information 41 is printed from the rear face 4b of the front panel 4. Thereafter, the sensor area Y and the lamp transmitting part 42 are masked, and black printing is performed from the rear face 4b (black printing is performed also for the groove part 4j). Thereafter, printing in which light is diffused from the rear face 4b is performed for the lamp transmitting part 42. Thereafter, a filter (not illustrated in the drawing) cutting visible light is provided on the rear face 4b of the sensor area Y.

Next, a method of mounting the sound imitating device 100 described above at a wall will be described.

First, a screw (not illustrated in the drawing) is inserted into and passes through a mounting hole b2 (see FIG. 2) of the bracket B is stopped at the wall. The VVF cable c1 inside the wall is pulled from the wire pulling-in opening 11h of the lower case 1 and is connected to the terminal unit 80. The wire pulling-in opening 11h is closed using the power supply cover 11k. At this time, the volume of an imitation sound and the like are adjusted by operating the switch 70.

Next, a screw 16z is inserted into and passes through the fixed cylindrical part 16 of the lower case 1 and is screwed into the fixed cylindrical part 36 of the upper case 2 of which the front panel 4 is fixed, whereby the upper case 2 and the lower case 1 are integrated together.

Next, the locking piece b1 of the bracket B is locked into the cylindrical locking part 17 of the lower case 1. In this way, the sound imitating device 100 is mounted on the wall through the bracket B.

In the sound imitating device 100 described above, when a user holds the hand over the front side of the operation information 41, an optical signal transmitted from the light transmitting device 66a reaches the hand (object target) and is reflected, and the light receiving device 67 receives a reflected signal. The light receiving device 67 transmits a detection signal to the control unit on the basis of the reflected signal. The control unit transmits an output signal to the speaker unit 90. The speaker unit 90 outputs an imitation sound on the basis of the output signal and stops the imitation sound after a predetermined time elapses.

In addition, when a user holds their hand over the front side of the operation information 41 during the output of the imitation sound, similar to the description presented above, an optical signal transmitted from the light transmitting device 66a reaches the hand and is reflected, and the light receiving device 67 receives the reflected signal. The sensor unit 60 transmits a detection signal to the control unit on the basis of the reflected signal. The control unit transmits a stop signal to the speaker unit 90. The speaker unit 90 stops the output of the imitation sound on the basis of the stop signal. In addition, even in a case in which a user forgets to stop the output of imitation sound by holding their hand in front of the operation information 41 during the output of the imitation sound, when the sensor unit 60 does not detect a user, the output of the imitation sound may be configured to automatically stop.

In addition, when the detection signal is received, the control unit transmits a lamp output signal to the operating lamp 50.

When the lamp output signal is received, the operating lamp 50 turns on the lamp, and the lamp is turned off after a predetermined time elapses.

In addition, in a case in which a user is present in front of the sound imitating device 100 or a user enters the toilet compartment and stands in front of the toilet compartment, optical signals transmitted from the light transmitting devices 66b and 66c reaches the user and are reflected, and the light receiving device 67 receives the reflected signals. The light receiving device 67 transmits a detection signal on the basis of the reflected signals. The control unit transmits an output signal to the speaker unit 90. The speaker unit 90 outputs an imitation sound on the basis of the output signal, and the imitation sound is stopped after a predetermined time elapses.

In the sound imitating device 100 configured in this way, the operation information 41 displayed on the panel arranged in front of the sensor unit 60 is arranged on the right side of the sensor unit 60 in the front view. Accordingly, the operation information 41 is not arranged to overlap the sensor unit 60 in the front view, and thus, an optical signal transmitted from the light transmitting device 66a is not blocked by the operation information 41. In addition, since the light transmitting device 66a is arranged to be capable of being directed toward the front side of the operation information 41, the optical signal reaches the hand held over the front side of the operation information 41 (target object). Furthermore, the operation information 41 is not arranged to overlap the sensor unit 60 in the front view, and accordingly, the reflected signal acquired when the optical signal reaches the target object and is reflected is not blocked by the operation information 41 and arrives at the light receiving device 67. Accordingly, the sensor unit 60 can accurately detect the hand.

In addition, for example, even when the center of a user's hand is arranged at a position deviating from the light transmitting device 66a to the operation information 41 side, the light transmitting device 66a is gradually directed toward a side approaching the operation information 41 in the front view as going to the front side, and accordingly, the user's hand can be detected reliably.

In addition, the light transmitting device 66a is arranged in closer proximity to the operation information 41 than the light transmitting devices 66b and 66c. Accordingly, the light transmitting device 66a can reliably detect a hand shown in the operation information 41. In addition, the light transmitting devices 66b and 66c arranged to be capable of being directed toward the front side can detect a user in front of the facility device 100 (human body detection).

In addition, the transmission ranges of optical signals transmitted from the light transmitting devices 66a, 66b, and 66c form a fan shape as a whole. Accordingly, inside a toilet compartment, in a case in which the light transmitting device 66a is arranged on an entrance door side, the light transmitting device 66a can detect a user and the like entering from the entrance door. In addition, inside a toilet compartment, in a case in which the light transmitting device 66c is arranged on the entrance door side, the light transmitting device 66c can detect a user and the like entering from the entrance door. Furthermore, in a case in which the sensor unit 60 is arranged on the lateral side of the toilet compartment, the light transmitting device 66b can detect a user and the like using the toilet compartment. In this way, the light transmitting devices 66a, 66b, and 66c can detect a user present at various positions in accordance with the installation position of the sound imitating device 100.

In addition, when the detection signal is received during the output of the imitation sound, the control unit transmits a stop signal used for stopping the output of the imitation sound. The speaker unit 90 stops the output of the imitation sound on the basis of the stop signal. Accordingly, in accordance with detection of a target object using one sensor unit 60, outputting and stopping of the imitation sound can be performed, and thus, a sensor for outputting the imitation sound and a sensor for stopping the imitation sound do not need to be separately provided, and the compactness of the sound imitating device 100 can be achieved.

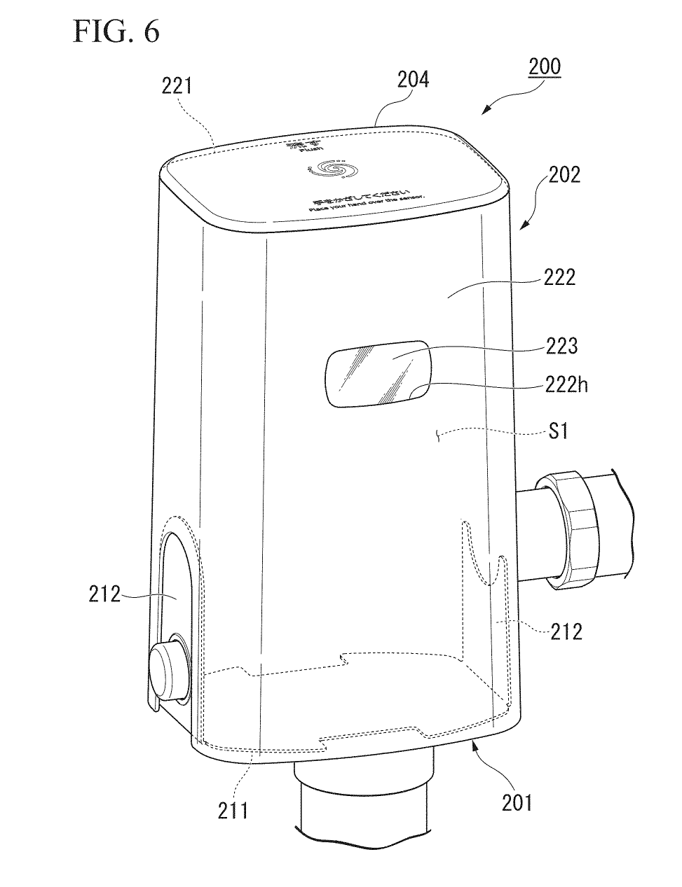

Next, a modified example of one embodiment of the invention will be described mainly with reference to FIGS. 6 to 8.

In the following description, the same reference signal is assigned to the same member as that described above, and description thereof will not be presented.

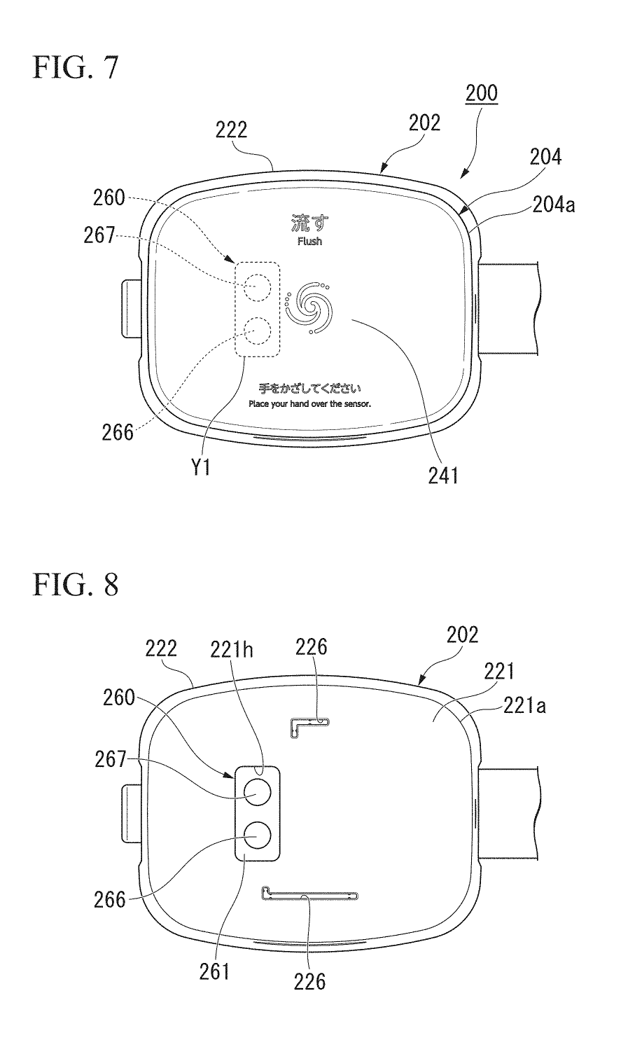

FIG. 6 is a perspective view of a flushing switching device according to a modified example of one embodiment of the invention that is seen from a diagonally-forward side. FIG. 7 is a perspective view of a flushing switching device according to the modified example of one embodiment of the invention that is seen from above. FIG. 8 is a view seen from above with an upper panel of a flushing switching device according to the modified example of one embodiment of the invention detached.

The flushing device according to this modified example illustrated in FIGS. 6 to 8 is a flushing switching device that is a switch flushing a flushing toilet. The flushing switching device 200 includes a lower case body 201, an upper case body 202 provided on the upper portion the lower case body 201, and an upper panel (panel) 204 provided on an upper face of the upper case body 202.

As illustrated in FIG. 6, the lower case body 201 includes a bottom wall part 211 arranged along an approximately horizontal plane and erected wall parts 212 erected from both left and right end portions of the bottom wall part 211 toward the upper side.

The upper case body 202 includes an upper face part 221 arranged along an approximately horizontal plane and a side covering part 222 that extends from the outer edge of the upper face part 221 to the lower side.

As illustrated in FIG. 8, the upper face part 221 is formed in a plate shape and is arranged to have a plate thickness direction toward the vertical direction. The upper face part 221 is formed in an approximately rectangular shape in the front view of the upper face part 221 (seen from above) and has four corner portions formed in an arc shape.

In the upper face part 221, a sensor mounting hole 221h penetrating in the vertical direction is formed. The sensor mounting hole 221h is arranged at approximately center of the upper face part 221 in the forward/backward direction (the vertical direction of a sheet face illustrated in FIG. 8). In the upper face part 221, an engaging groove 226 that is concave on the lower side is formed.

A side covering part 222 is formed on the circumference of the upper face part 221. As illustrated in FIG. 6, in the side covering part 222, on the front side (the user side), a human body sensor mounting hole 222h passing through in the forward/backward direction is formed. The human body sensor mounting hole 222h is closed by a closing plate 223.

In a housing space S1 formed by the lower case body 201 and the upper case body 202, functional units such as a sensor unit (sensor) 260 (see FIG. 8), a control unit (not illustrated in the drawing), and a flushing mechanism (not illustrated in the drawing) are housed.

As illustrated in FIG. 8, the sensor unit 260 is arranged in the sensor mounting hole 221h of the upper face part 221 in the front view of the upper face part 221. The sensor unit 260 includes a casing 261 and a light transmitting device (a light transmitting unit; a first light transmitting unit) 266 and a light receiving device (a light receiving unit) 267 arranged inside the casing 261. The light transmitting device 266 is arranged on a further front side (the user side) than the light receiving device 267.

As illustrated in FIG. 7, the light transmitting device 266 is arranged toward the upper side of operation information 241 of an upper panel 204 to be described later. The light transmitting device 266 can detect (orient) a hand or the like held over on the upper side of the operation information 241 by transmitting an optical signal toward the upper side of the operation information 241. The light receiving device 267 is arranged toward the upper side of the operation information 241. The light receiving device 267 can receive a reflected signal reflected by the hand held over on the upper side of the operation information 241.

As illustrated in FIG. 6, inside the housing space S, a light transmitting device and a light receiving device (not illustrated in the drawing) for a human sensor are arranged at a position corresponding to the closing plate 223 of the upper case body 202.

The upper panel 204 is formed in a plate shape and is arranged to have the plate thickness direction directed in the vertical direction.

In the front view of the upper panel 204, the upper panel 204 is formed in an approximately same shape as that of the upper face part 221 of the upper case body 202. A vertical length and a horizontal length of the upper panel 204 are approximately the same as a vertical length and a horizontal length of the upper face part 221. In the front view of the upper panel 204, an outer edge portion (end portion) (see FIG. 7) 204a of the upper panel 204 is arranged to overlap an outer edge portion (end portion) 221a (see FIG. 8) of the upper face part 221. The outer edge portion 204a of the upper panel 204 is exposed without covering with the upper face part 221.

An engaging protrusion (not illustrated in the drawing) having a shape corresponding to the engaging groove 226 (see FIG. 8) of the upper face part 221 of the upper case body 202 is provided in a lower face of the upper panel 204. By engaging the engaging protrusion with the engaging groove 226, the upper panel 204 is mounted on the upper face of the upper face part 221 of the upper case body 202. In addition, the upper panel 204 may be mounted on the upper face part 221 by sticking a double-sided tape (not illustrated in the drawing) on the lower face of the upper panel 204.

As illustrated in FIG. 7, on the upper panel 204, a position corresponding to the sensor unit 260 in the front view is configured as a sensor area Y1 into which the light transmitting device 266 of the sensor unit 260 can diffuse.

Operation information (a display portion) 241 guiding a target object to a predetermined position is provided at the approximately center of the upper panel 204 in the horizontal direction. In other words, the operation information 241 is arranged to the right side of the sensor unit 260 while being adjacent to the sensor unit 260 in the front view. In this embodiment, a pictogram (pictographic script) representing a flow (whirlpool) of water and texts written as “Hold over your hand,” “Place your hand over the sensor.” are illustrated as operation information 241. In addition, texts “flush” and “Flush” are written behind (the above of the page of FIG. 7) such operation information 241.

According to the flushing switching device 200 described above, when a user holds his or her hand over the operation information 241, an optical signal transmitted from the light transmitting device 266 reaches the hand (target object) and is reflected, and the light receiving device 267 receives a reflected signal. The light receiving device 267 transmits a detection signal to the control unit on the basis of the reflected signal. The control unit transmits an output signal to the flushing mechanism. The flushing mechanism operates a pump or the like on the basis of the output signal, thereby causing cleaning water to flow out.

In addition, when the user leaves, an optical signal transmitted from the light transmitting device for the human body sensor reaches the user and is reflected, and the light receiving device for the human body sensor receives the reflected signal. The light receiving device for the human body sensor transmits a detection signal to the control unit on the basis of the reflected signal. The control unit transmits an output signal to the flushing mechanism. The flushing mechanism operates a pump or the like on the basis of the output signal, thereby causing cleaning water to flow out.

In the flushing switching device 200 configured as such, the operation information 241 displayed on the upper panel 204 arranged above the sensor unit 260 is arranged on the right side of the sensor unit 260 in the front view (seen from above). Accordingly, the operation information 241 is not arranged to overlap the sensor unit 260 in the front view, and thus, an optical signal transmitted from the light transmitting device 266 is not blocked by the operation information 241. In addition, since the light transmitting device 266 is arranged to be capable of being directed the operation information 241 side, the optical signal arrives up to the hand (target object) held over the operation information 241. In addition, since the operation information 241 is not arranged to overlap the sensor unit 260 in the front view, a reflected signal acquired when an optical signal reaches a target object and is reflected is not blocked by the operation information 241 but arrives at the light receiving device 267. Accordingly, the sensor unit 260 can accurately detect the hand.

The shapes, combinations, and the like of the constituent members illustrated in the embodiment described above are examples, and various changes may be made on the basis of a design request or the like within a range not departing from the main concept of the invention.

For example, in the embodiment described above, although the sound imitating device 100 and the flushing switching device 200 have been described as examples of the facility device, the invention is not limited thereto but may be applied to any other facility device.

In addition, in the first embodiment, a flushing mechanism may be included instead of the speaker unit 90. In such a case, the control unit transmits an output signal to the flushing mechanism, and the flushing mechanism operates a pump or the like on the basis of the output signal and causes flushing water to flow out.

In addition, in the embodiment described above, although the sound imitating device 100 having a form in which the bracket B is arranged on the wall face, the sound imitating device 100 is mounted in the bracket B, and power is supplied from the VVF cable c1 has been described as an example, the invention is not limited thereto. A so-called battery-type sound imitating device having a form in which a bracket is disposed on a wall face, the sound imitating device is mounted in the bracket, and power is supplied form a battery arranged inside the sound imitating device may be employed. Alternatively, a so-called embedded type sound imitating device 100 having a form in which a bracket formed in a four-side frame shape is arranged in a through hole formed in a wall, and the lower case is housed inside the bracket may be employed.

In addition, in the embodiment described above, although the operation information 41 is arranged to the right side of the sensor unit 60 in the front view, the invention is not limited thereto. In the front view, the display portion may not be arranged adjacent to the sensor and may be arranged on the upper side, the lower side, the right side, or the like of the sensor.

In addition, in the embodiment described above, although the control unit is configured to transmit an output signal used for outputting an imitation sound at a normal time and transmit a stop signal for stopping the output of the imitation sound during the output of the imitation sound, the invention is not limited thereto. A sensor used for execution of a predetermined function and a sensor for stopping a predetermined function may be separately provided.

In addition, the first light transmitting unit may not be inclined toward the display portion side but be directed toward one side of the first light transmitting unit (for example, the front side in the first embodiment). In such a case, when a user's hand is arranged at a position overlapping the first light transmitting unit in the front view, the user's hand can be detected.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A facility device comprising:
a sensor which includes a light transmitting unit that transmits an optical signal and a light receiving unit that receives a reflected signal which is the optical signal transmitted from the light transmitting unit, reached a target object, and reflected, the light receiving unit transmitting a detection signal on the basis of the received reflected signal; and
a panel which is arranged at a position in a first direction from the sensor,
wherein a display portion is provided on the panel, the display portion being configured to guide the target object to be placed at a predetermined position,
wherein the light transmitting unit includes a first light transmitting unit that is arranged to be capable of being directed toward a location which is in the first direction from the display portion, and
wherein the display portion is arranged adjacent to the sensor in a front view of the facility device.

2. The facility device of claim 1, wherein
the first light transmitting unit is oriented toward a direction that goes closer to the display portion in the front view of the facility device as gradually going to the first direction.

3. The facility device of claim 1,
wherein the light transmitting unit includes a second light transmitting unit arranged to be capable of being directed toward the first direction, and
wherein the first light transmitting unit is arranged closer to the display portion than the second light transmitting unit in the front view of the facility device.

4. The facility device of claim 1, further comprising:
a control unit which transmits an output signal that causes a predetermined function to be executed on the basis of the detection signal; and
a function executing unit which executes the predetermined function on the basis of the output signal,
wherein, when the detection signal is received during an execution of the predetermined function, the control unit transmits a stop signal that causes the predetermined function to be stopped, and
wherein the function executing unit stops the execution of the predetermined function on the basis of the stop signal.
